(19) United States
(12) Patent Application Publication
(10) Pub. No.: US 2018/0000057 A1
(43) Pub. Date: Jan. 4, 2018

(54) RATTLING PADDLE LURE

(71) Applicant: Joseph William Jarboe, JR., Fort Smith, AR (US)

(72) Inventor: Joseph William Jarboe, JR., Fort Smith, AR (US)

(73) Assignee: Plastic Research and Development Corporation, Birmingham, AL (US)

(21) Appl. No.: 15/638,845

(22) Filed: Jun. 30, 2017

Related U.S. Application Data
(60) Provisional application No. 62/357,347, filed on Jun. 30, 2016.

(51) Int. Cl. A01K 85/01; A01K 85/16

(52) U.S. Cl. CPC A01K 85/01; A01K 85/16

(57) ABSTRACT

A rattling solid body lure utilizes a paddle assembly made from a sound transmitting material wherein an enlarged portion of the paddle extending within the lure body includes a weight well in which freely mounted weight is captured. A wire form defining a pull eye and hook hangers is molded within the paddle and the paddle and wire form are over molded with a foam lure body.

This application claims priority from U.S. Provisional Patent Application Ser. No. 62/357,347, entitled RATTLING PADDLE LURE, filed Jun. 30, 2016, which is incorporated herein for all purposes.

### FIELD OF INVENTION

This invention relates to fishing lures and more particularly to solid body casting lures having a diving paddle. In even greater particularity, the present invention relates to a solid body casting lure having a diving paddle wherein there is a rattle chamber built into the paddle rather than the lure body.

### BACKGROUND

Fishermen consistently seek ways to attract fish to their lures. One of the well-known methods of attracting fish is by sound, thus, it is known to place rattles or beads in sound chambers, which general look like capsules, which can be inserted into plastic worms, glued onto spinner blades, or molded inside lure bodies. Such sound chambers are made from hard plastic or glass such as Pyrex and contain from one to three metal balls which are free to move within the chamber. However, solid lure bodies made of wood or foam have an acoustic damping effect which reduce the amplitude of the transmitted vibrations created by an internal rattle, and therefore lessen the effect of the rattle when formed inside the body. Adding a lure externally of the body can change the running characteristics of the lure in the water. Thus, a need exists for a means to provide an effective acoustic a rattle that can be used with a solid body lure without changing the running characteristics of the lure.

### BRIEF DESCRIPTION OF THE DRAWINGS

Referring to the drawings which are appended hereto and which form a portion of this disclosure, it may be seen that:

FIG. 1 is an exploded view of a first embodiment my improved lure and paddle;

FIG. 2 is a sectional view of the first embodiment.

FIG. 3 is a rear view of the first embodiment.

FIG. 4 is a front view of the first embodiment;

FIG. 5 is a side view of the first embodiment;

FIG. 6 is an exploded view of a second embodiment;

FIG. 7 is a top plan view of the first embodiment;

FIG. 8 is a bottom view of the first embodiment; and,

FIG. 9 is a perspective view of the first embodiment.

### DETAILED DESCRIPTION

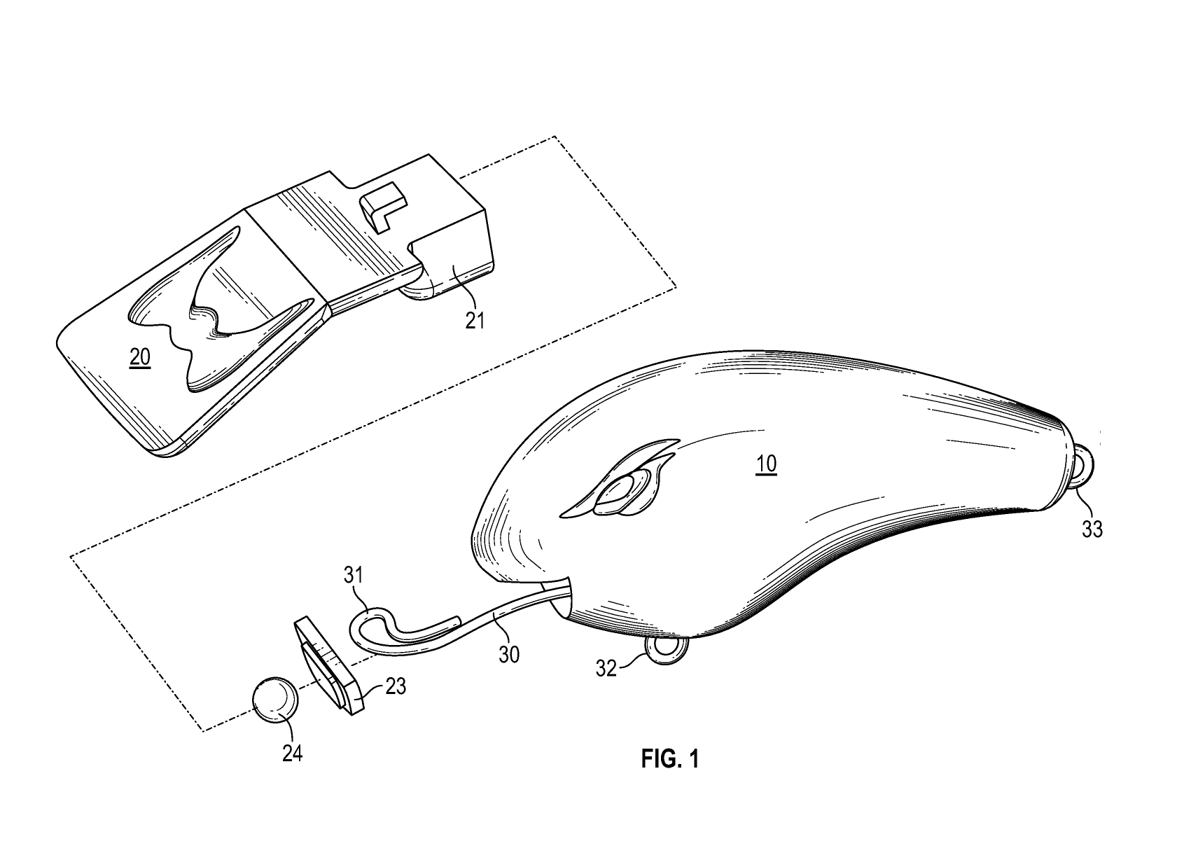

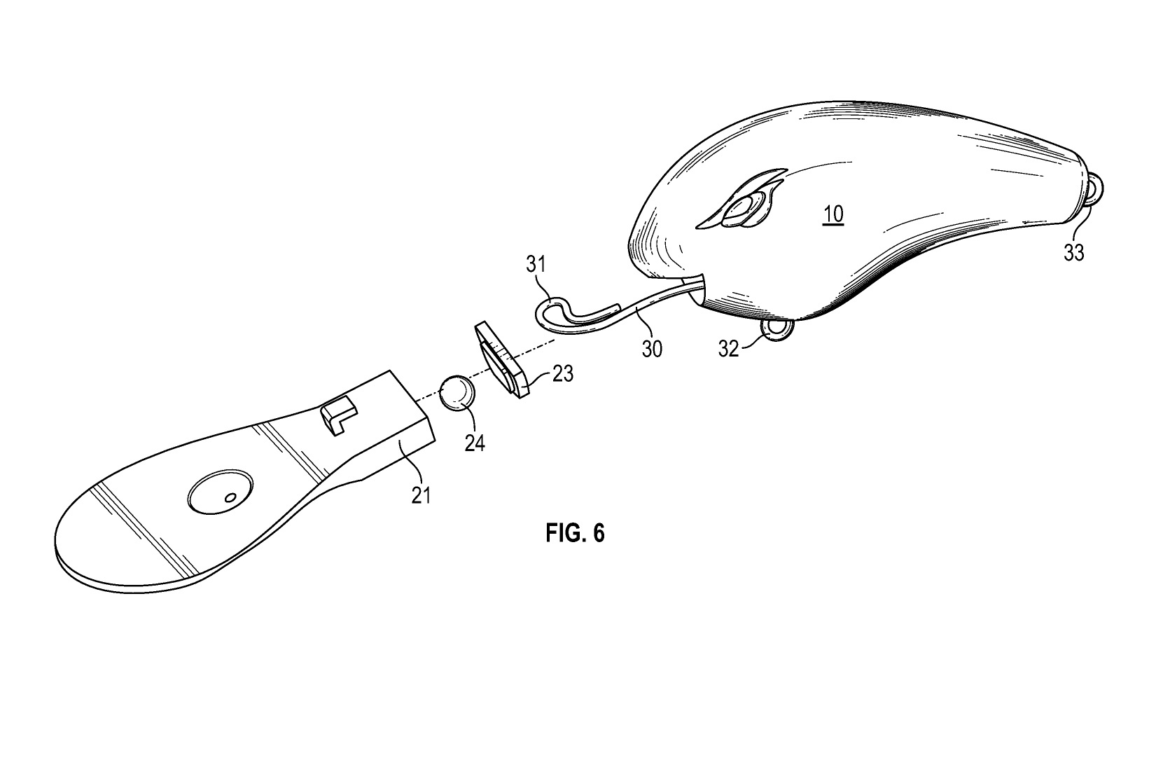

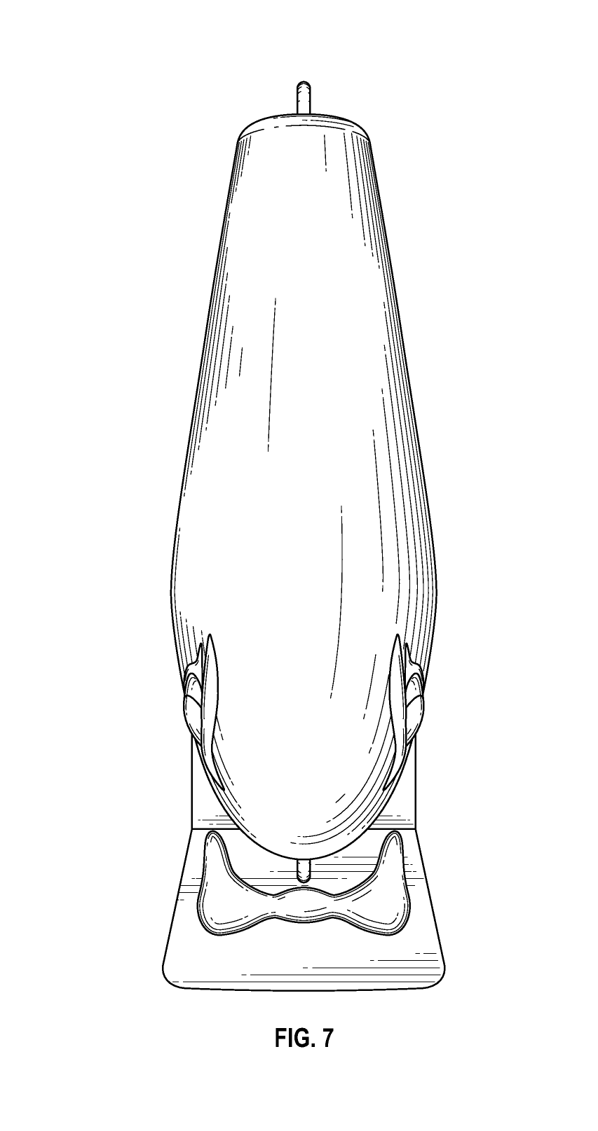

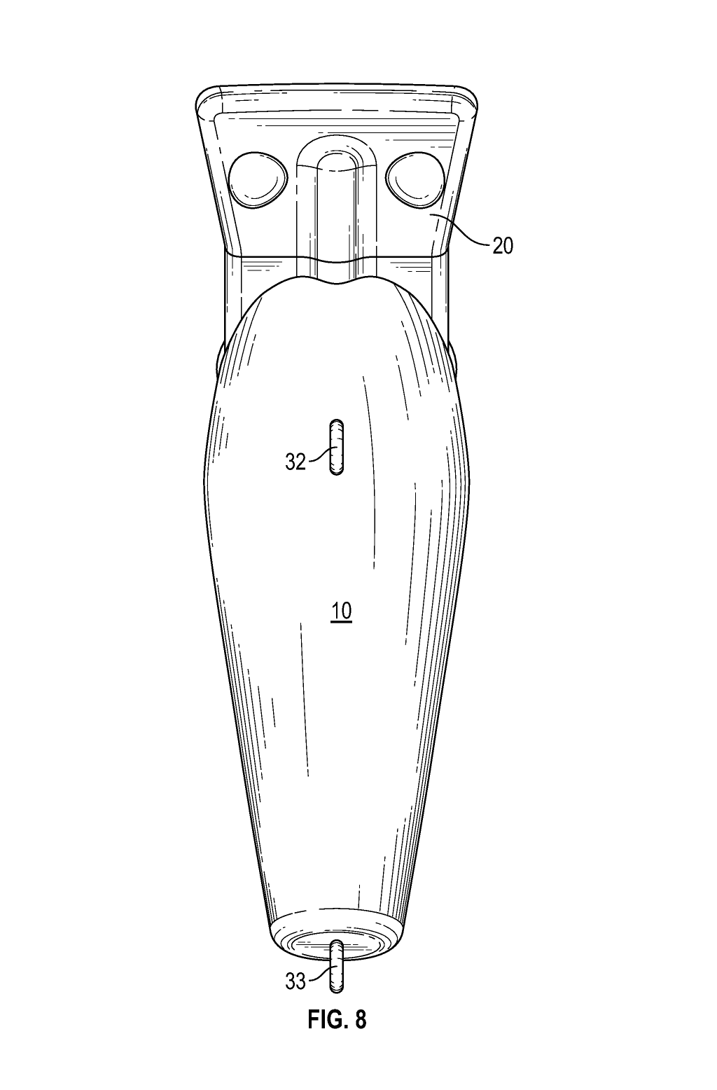

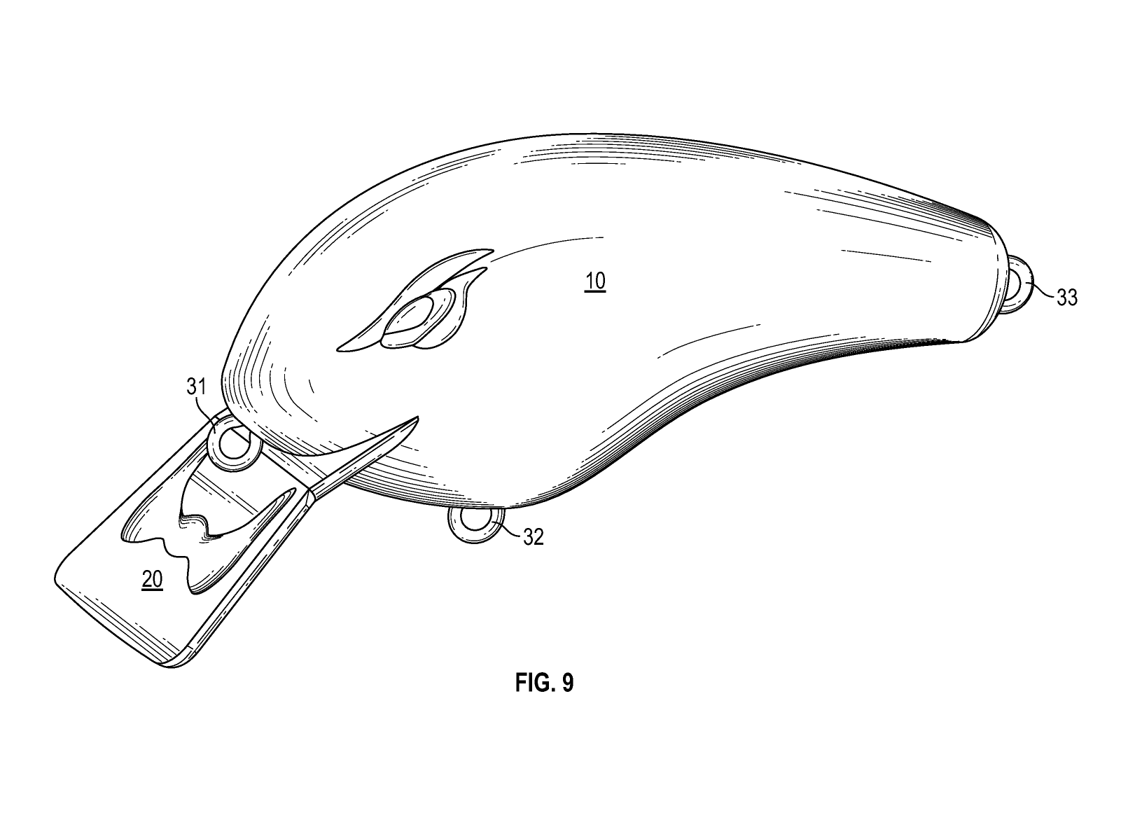

One or more of the above objects can be achieved, at least in part, by providing a rattle in the paddle of the lure. Referring to FIG. 1, it may be seen that my improved lure includes a body 10, a paddle 20 and a wire form 30. The improved lure looks substantially identical to conventional lures however, it may be observed that the base portion 21 of the paddle 20 where it joins the body 10 of the lure is substantially thicker vertically than the rest of the paddle. Paddle 20 is made from a hard material such as polycarbonate which can be readily molded using known techniques. Of course, other materials providing similar acoustic transmission such as metal may be used to make paddle 20, however the polycarbonate paddles have both desirable transmission and weight characteristics. Likewise the paddle may have a different shape as shown in a second embodiment presented in FIG. 6.

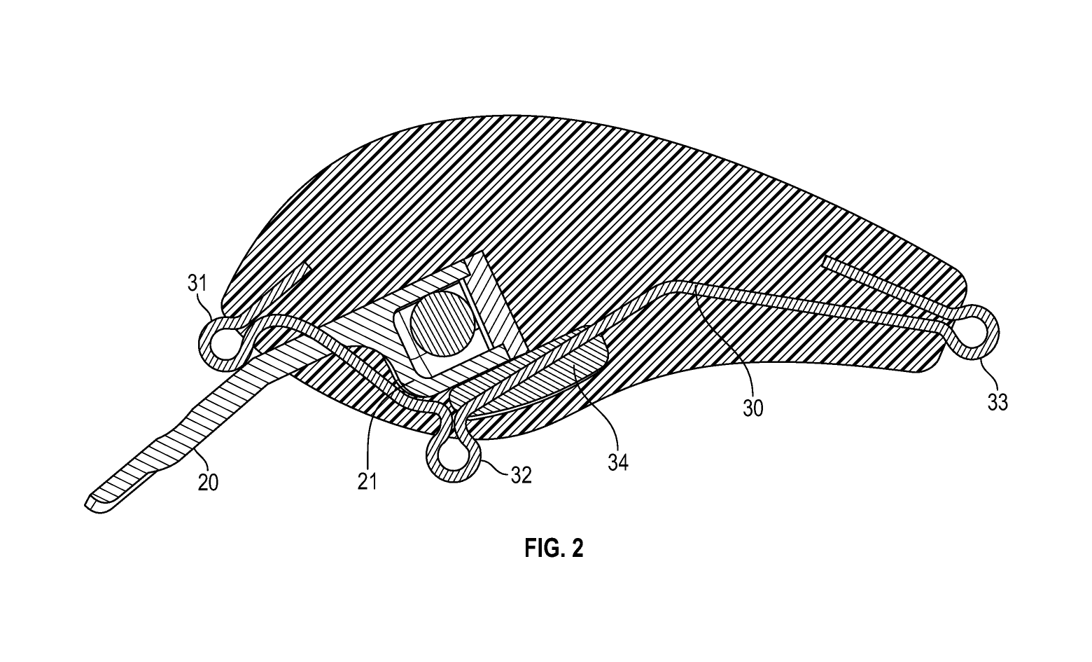

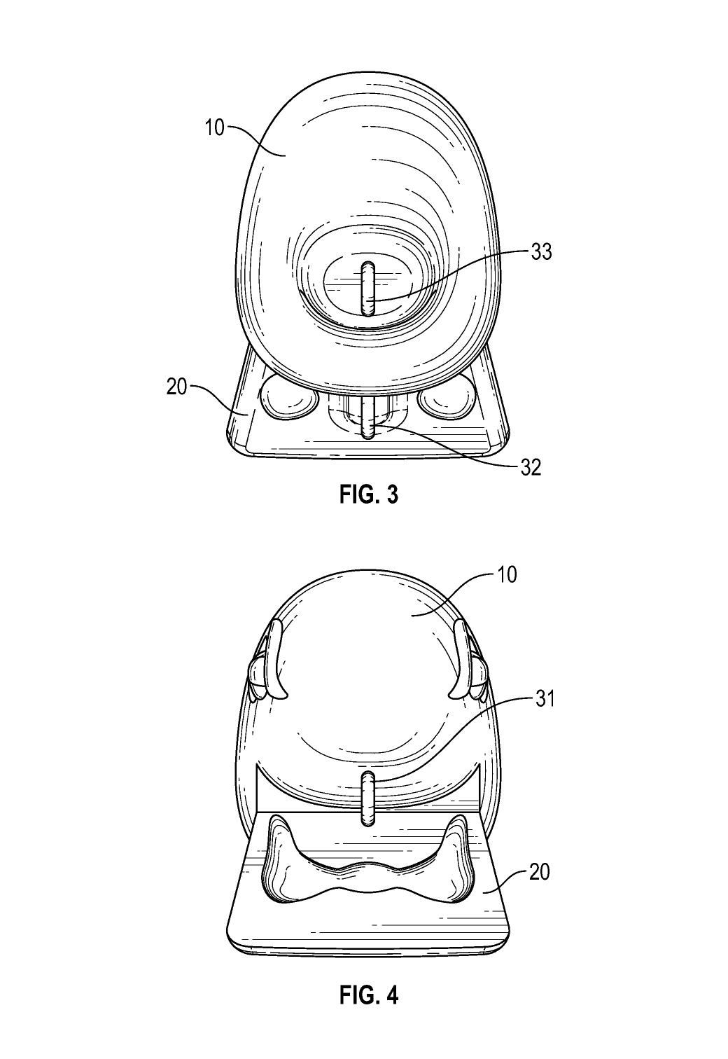

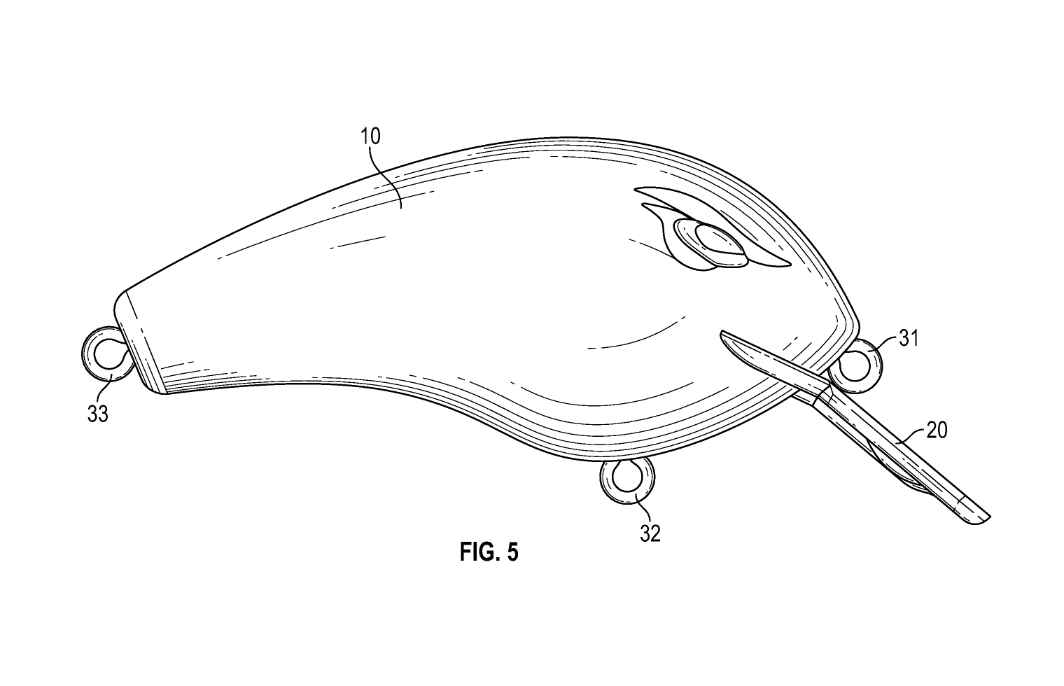

Referring to FIGS. 1, 2, and 6, it can be seen that the polycarbonate paddle is formed with a rattle chamber 22 or weight well in the thickened base portion 21 of the lure. The chamber 22 has a rear opening which is closed with a polycarbonate endcap 23 which preserves the space for the tungsten weight 24 which is loosely captured there within. The rigidity of the polycarbonate material makes it an excellent sound conductor and the material is capable of withstanding the over molding heat.

It is noteworthy to mention that the construction of the paddle and the wire form makes the lure very robust. Specifically, I follow the following procedure. I first make the wire form 30 including a pull-eye 31 a bottom hanger 32 for attachment of a hook or hook assembly, and a tail hanger 33 for attachment of an additional hook either alone or in combination with a spinner or the like. I then cast a keel weight 34 around the wire form, with the keel weight having sufficient mass to provide proper ballast to the lure. The polycarbonate paddle is then molded about the wire form 30 to provide a unitary assembly. Tungsten weight 24 of the proper weight and size is placed into the weight chamber 22 and the endcap is glued or welded to the paddle assembly to secure the weight 24 into the weight well 22. The completed paddle assembly is placed into the body mold and over mold the foam body to the paddle 20 and about the wire form 30. This procedure keeps the wire in a very precision position that allows a true running lure. The body is made of foamed ABS or Styrene to have the buoyancy and strength. Over molding processes are commonly understood and will not be discussed herein.

Because the lure uses a small amount more poly carbonate in the paddle and because the rattle weight adds significant weight to the foam body, a lure made as described can be smaller but weigh the same for greater casting distances and much more durable than traditionally made lures.

It should be understood that the retrieval of the lure through the water creates resistance between the forwardly and downwardly extending paddle and the water, causing the lure to wobble during the retrieve. In turn, the wobble causes the weight 24 to impact the inner walls of the weight well within the paddle, inducing vibration which is transmitted virtually undamped to the protruding paddle for subsequent dispersal into the water about the lure.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention. While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

What we claim is:

1. A fishing lure having a forwardly extending paddle, said paddle defining a weight well in a first end, a lure body attached to at least said first end by an over molding process, and a wire form for connection one or more hooks to said body and to a pull point on said wireframe.

2. A fishing lure as defined in claim 1 wherein said paddle is formed from polycarbonate.

3. A fishing lure as defined in claim 2 wherein said paddle is molded with a portion of said wire form embedded within said paddle.

4. A fishing lure as defined in claim 2 wherein said body is made from foam.

5. A fishing lure as defined in claim 1 wherein said forwardly extending paddle includes a forward portion extending from said lure and an enlarged portion at least partially contained within said lure, said enlarged portion defining said weight well there within.

6. A fishing lure as defined in claim 5 wherein said weight well loosely confines at least one weight member and is sealed by a cover.

7. A fishing lure as defined in claim 6 wherein said forwardly extending paddle is made from a material that transmits sound from said weight well.

8. A fishing lure as defined in claim 6 wherein said paddle is formed from polycarbonate.

9. A fishing lure as defined in claim 8 wherein said paddle is molded with a portion of said wire form embedded within said paddle.

10. A fishing lure as defined in claim 9 wherein said body is made from foam.

11. A fishing lure as defined in claim 10 wherein said wire form includes a pull ring providing an attachment point for a fishing line, a belly loop providing an attachment point for at least one hook, a tail loop providing an attachment point for at least one hook and a keel weight providing balance and mass to said lure.

12. A method for fabricating a fishing lure comprising the steps of:
a. Bending a wire form to include a pull-eye to which a fishing line may be attached, and at least one hook hanger to be located on the belly or tail of the lure,
b. Securing a keel weight to the wire form at a position and of such weight as to provide proper ballast to the lure;
c. Molding a paddle to said wire form to create a unitary paddle and wire form assembly, said paddle including a forwardly protruding portion and an enlarged portion defining a weight well;
d. Inserting a weight of desired size and shape into said weight well;
e. Sealing the weight well with said weight captured therein such that said weight is free to move within the weight well;
f. Molding a solid lure about said paddle and wire form assembly with said paddle protruding from said lure and said at least one hook hanger extending from said lure.

13. The method as defined in claim 12 wherein said solid lure is molded using a foam material.

14. The method as defined in claim 12 wherein said paddle is molded from a polycarbonate material.
